(19) United States
(12) Patent Application Publication
(10) Pub. No.: US 2008/0022450 A1
(43) Pub. Date: Jan. 31, 2008

(54) Holder device for shower head and nozzle

(76) Inventor: Pi Kuang Tsai, Taichung (TW)

Correspondence Address: CHARLES E. BAXLEY, ESQ., 90 JOHN STREET, THIRD FLOOR, NEW YORK, NY, 10038, US

(21) Appl. No.: 11/901,862

(22) Filed: Sep. 19, 2007

Related U.S. Application Data
(63) Continuation-in-part of application No. 11/080,014, filed on Mar. 14, 2005, now Pat. No. 7,299,510.

(51) Int. Cl. B05B 15/06; A47K 3/20

(52) U.S. Cl. 4/570; 248/75

(57) ABSTRACT

A holder device may be attached to a water outlet tube which is extended from a wall, without drilling holes in the wall, and includes a shower arm having an inlet attached to the water outlet tube, and two or more outlet ports for attaching a shower head and a sprayer nozzle simultaneously. The housing includes an attaching device for attaching the sprayer nozzle to the housing. A valve stem is rotatably attached in the housing for controlling the water to selectively flow out through either of the outlet ports of the housing, and a spring-biased valve member is received in the valve stem to engage with either of the valve seats and to control the water to flow out through the outlet ports of the housing.

The present invention is a continuation-in-part of U.S. patent application Ser. No. 11/080,014, filed 14 Mar. 2005, pending.

### BACKGROUND OF THE INVENTION

1. Field of the Invention

The present invention relates to a holder device and/or a control device, and more particularly to a holder and control device for supporting shower heads and shower nozzles, and for controlling the water to flow out through either or both of the shower heads and the nozzles.

2. Description of the Prior Art

Typical holder devices for supporting shower nozzles or other appliances comprise a bracket attached or secured to upper portions of supporting surfaces or walls or the like with fasteners. One or more holes should be drilled into the supporting surfaces or walls or the like with drilling machines or tools, for allowing the fasteners to be threaded into the supporting surfaces or walls or the like.

However, many families have no drilling machines or tools, and may not easily drilling the holes into the supporting surfaces or walls or the like by themselves, such that the typical appliance holders may not be easily mounted by the users themselves.

The other typical holder devices for supporting shower nozzles or other appliances comprise one or more shower heads or shower nozzles attached to an upper horizontal section of a curved shower arm for allowing the shower heads or shower nozzles to be attached onto the supporting surfaces or walls or the like without fastening members.

For example, U.S. Pat. No. 3,112,073 to Larson et al. discloses one of the typical appliance holders including a standard circular shower head attached or secured to the curved shower arm with a control unit, and a hollow rinsing head attached or secured to the control unit for allowing the shower heads or shower nozzles to be attached onto the supporting surfaces or walls or the like without fastening members, and a control valve disposed in the control unit for controlling the water to flow through either of the standard circular shower head or the hollow rinsing head.

However, the hollow rinsing head is solidly attached or secured to the control unit and may not be removed or disengaged from the control unit and thus may not be moved toward or close to the user for showing purposes. In addition, the control unit has no support device and may not be used for detachably supporting the hollow rinsing head.

U.S. Pat. No. 3,979,096 to Zieger discloses another typical appliance holder including a bracket attached or secured to the water supply pipe for detachably supporting the shower head, without drilling holes into the supporting surfaces or walls.

However, the bracket may only be used for detachably supporting the shower head but may not be used to control the water flow through the shower nozzles or the shower heads.

The present invention has arisen to mitigate and/or obviate the afore-described disadvantages of the conventional holder devices for supporting shower heads and shower nozzles.

### SUMMARY OF THE INVENTION

The primary objective of the present invention is to provide a holder device directly attached to the water outlet tube that is provided and extended from the supporting surfaces or walls, for supporting shower heads and/or shower nozzles and the like.

The other objective of the present invention is to provide a holder device for readily attaching to the supporting surfaces or walls or the like without drilling holes in the supporting surfaces or walls or the like.

The further objective of the present invention is to provide a holder device for controlling the water to flow out through either or both of the shower heads and the nozzles.

In accordance with one aspect of the invention, there is provided a holder device for attaching to a water outlet tube which is typically extended from a wall and coupled to a water reservoir, the holder device comprising a shower arm including an inlet for attaching to the water outlet tube, and for receiving water from the water reservoir, and including a housing provided thereon, the housing including a first outlet port and at least one second outlet port, and the housing including a chamber formed therein and communicating with the inlet and the first outlet port and the second outlet port of the housing, and the housing including two valve seats formed in the housing and communicating with the first outlet port and the second outlet port of the housing respectively, a shower head attached to the first outlet port of the housing, a sprayer nozzle coupled to the second outlet port of the housing, an attaching device attached to the housing for supporting the sprayer nozzle, the attaching device including an opening formed therein for attaching the sprayer nozzle, a valve stem rotatably attached in the chamber of the housing, and including a passage formed therein for communicating the inlet of the housing with the first outlet port and the second outlet port of the housing, to allow the water to selectively flow out through the first outlet port and the second outlet port of the housing, a spring-biased valve member received in the valve stem to engage with either of the valve seats of the housing and to control the water to flow out through the first outlet port and the second outlet port of the housing, and a knob secured to the valve stem to rotate the valve stem relative to the housing.

The housing includes a partition secured thereto, the attaching device is rotatably attached to the partition. The partition includes a bore formed therein, a follower rotatably engaged in the bore of the partition secured to the attaching device.

The follower includes at least one key extended therefrom for keying and securing to the attaching device, and includes an enlarged head extended therefrom, for engaging with the partition, and for rotatably anchoring the follower to the partition, and for preventing the follower from sliding relative to the partition.

The valve stem includes a compartment formed therein, and the spring-biased valve member is received in the compartment of the valve stem.

The housing includes a spring-biased projection disposed therein, and engageable with the knob, to position the knob to the housing at selected position. The knob includes a barrel extended therefrom and attached to the valve stem.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a holder device in accordance with the present invention;

FIG. 2 is an exploded view of the holder device as seen from one side of the holder device;

FIG. 3 is another exploded view of the holder device as seen from the other side of the holder device;

FIG. 4 is a perspective view of the holder device;

FIG. 5 is a cross sectional view of the holder device, taken along lines 5-5 of FIG. 4;

FIGS. 6, 7 are cross sectional views similar to FIG. 5, illustrating the operation of the holder device;

FIG. 8 is a cross sectional view of the holder device, taken along lines 8-8 of FIG. 4; and

FIG. 9 is a cross sectional view similar to FIG. 8, illustrating the operation of the holder device.

### DETAILED DESCRIPTION OF THE PREFERRED EMBODIMENT

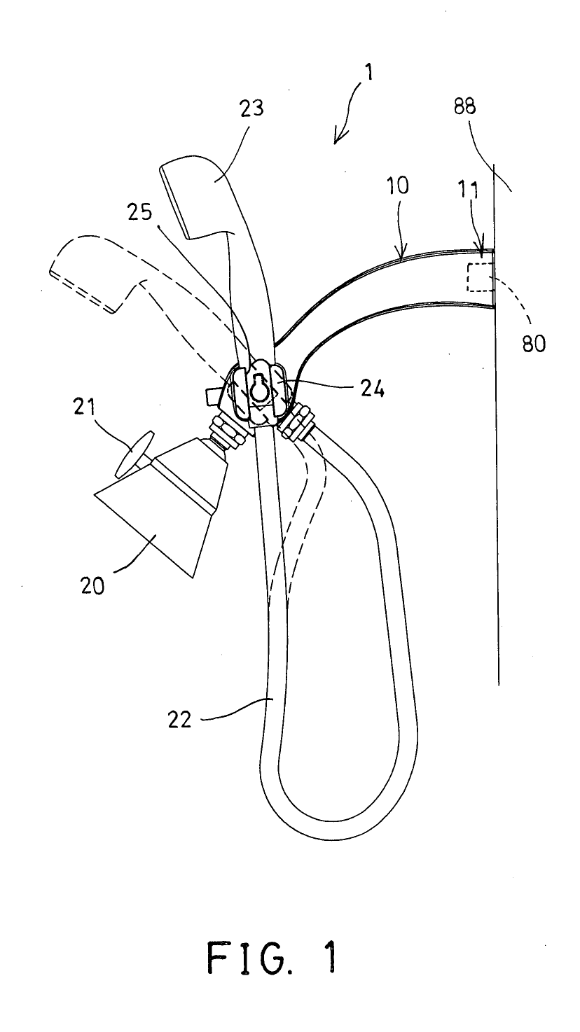

Referring to the drawings, and initially to FIGS. 1-5, a holder device 1 in accordance with the present invention comprises a housing or water supply pipe or shower arm 10 including an inlet 11 for attaching or securing to a water outlet tube 80 which is normally or typically attached onto or extended from a wall or a supporting surface 88 and coupled to the typical or conventional water reservoirs for receiving water from the water reservoirs, and thus for supplying the water to the shower arm 10. The shower arm 10 includes a water passageway 12 formed or provided therein and communicating with the inlet 11 thereof for receiving the water from the water reservoirs, and the above-described engagement of the water outlet tube 80 with the inlet 11 of the shower arm 10 is typical and will not be described in further details.

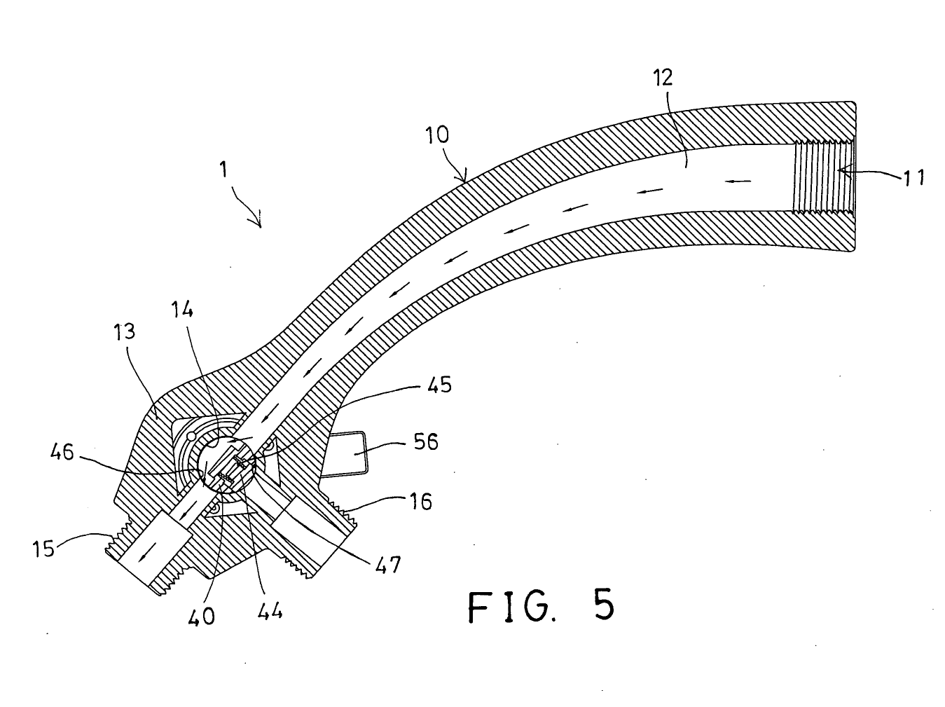

The shower arm 10 includes a housing 13 formed on one end thereof and located distal to the inlet 11 and/or the water outlet tube 80 and having a bore or chamber 14 formed or provided therein and communicating with the water passageway 12 of the shower arm 10, and further includes two or more outlet ports 15, 16 communicating with the chamber 14 of the housing 13 for allowing the water to flow out through either or both of the outlet ports 15, 16 of the housing 13 (FIGS. 5-7). For example, a standard circular shower head 20 (FIG. 1) attached or secured to the outlet port 15 of the housing 13 and/or controlled by a control valve or device 21, and a hose 22 attached or secured to the other outlet port 16 of the housing 13 for coupling to a sprayer nozzle 23.

The holder device 1 further includes an attaching device 24 attached or secured to one side portion 18 of the shower arm 10, and having an engaging opening 25 formed therein for hooking or attaching the sprayer nozzle 23 thereto, also best shown in FIG. 1. It is to be noted that the sprayer nozzle 23 may thus be easily and readily attached to the attaching device 24 which is attached or secured to one side portion 18 of the shower arm 10, and the shower arm 10 is directly attached or secured onto the water outlet tube 80, such that no holes are required to be drilled within the wall or the supporting surface 88, and thus no wall mounted brackets are required to be attached or secured to the supporting surfaces or walls or the like.

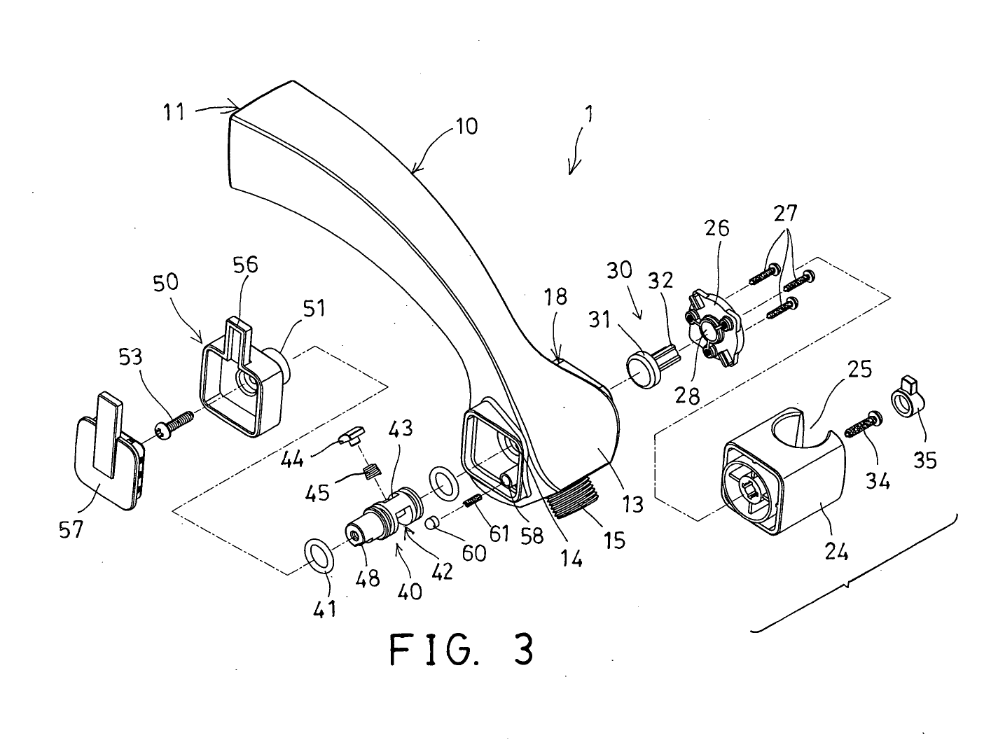

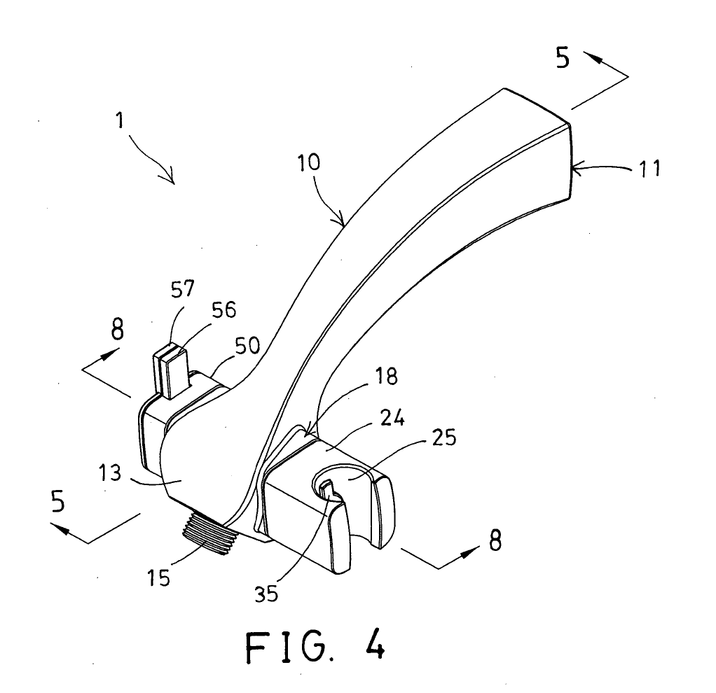

As shown in FIGS. 3 and 4, a partition 26 may be secured to the one side portion 18 of the shower arm 10 with one or more fasteners 27 and includes a bore 28 formed therein. A follower 30 is rotatably engaged or received within the bore 28 of the partition 26, and includes an enlarged head 31 extended therefrom, for engaging with the partition 26, and for rotatably anchoring the follower 30 to the partition 26, and thus for preventing the follower 30 from sliding laterally or longitudinally relative to the partition 26. The follower 30 further includes one or more keys or ribs 32 extended from or provided on the outer peripheral portion thereof for keying or engaging or securing to the attaching device 24, and thus for securing the attaching device 24 to the follower 30, and thus to allow the attaching device 24 to be rotated in concert with the follower 30.

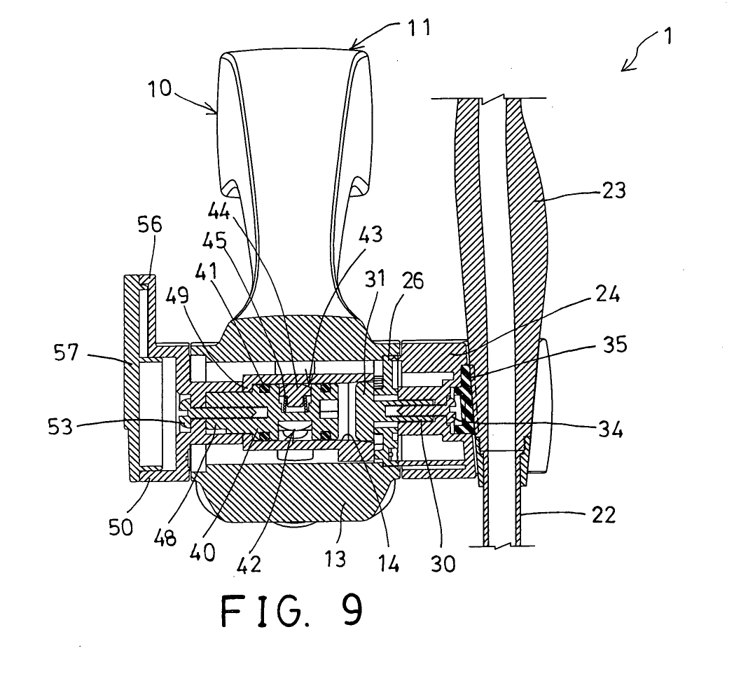

One or more fasteners 34 may further be provided and engaged with the attaching device 24 and secured to the follower 30, to further solidly secure the follower 30 to the attaching device 24. An end cap 35 may be attached onto the fastener 34, to enclose or to shield the fastener 34. It is preferable that the end cap 35 is made of resilient or soft rubber or plastic or synthetic materials for softly or frictionally engaging with the sprayer nozzle 23 (FIG. 9) and for stably anchoring or positioning the sprayer nozzle 23 to the attaching device 24 and for preventing the sprayer nozzle 23 from being vibrated relative to the attaching device 24. The sprayer nozzle 23 and the attaching device 24 may be suitably rotated relative to the housing 13 of the shower arm 10 to any suitable or selected angular position.

The holder device 1 further includes a valve stem 40 rotatably attached or received within the chamber 14 of the housing 13, or directly attached or received within the shower arm 10, and one or more sealing rings 41 attached or engaged onto the valve stem 40 and engaged with the housing 13 or the shower arm 10, and thus for making a water tight seal between the valve stem 40 and the housing 13 or the shower arm 10. The valve stem 40 includes a passage 42 formed therein for communicating the water passageway 12 of the shower arm 10 with either or both of the outlet ports 15, 16 of the shower arm 10 (FIGS. 5-7), to allow the water to selectively flow out through either or both of the two outlet ports 15, 16 of the shower arm 10.

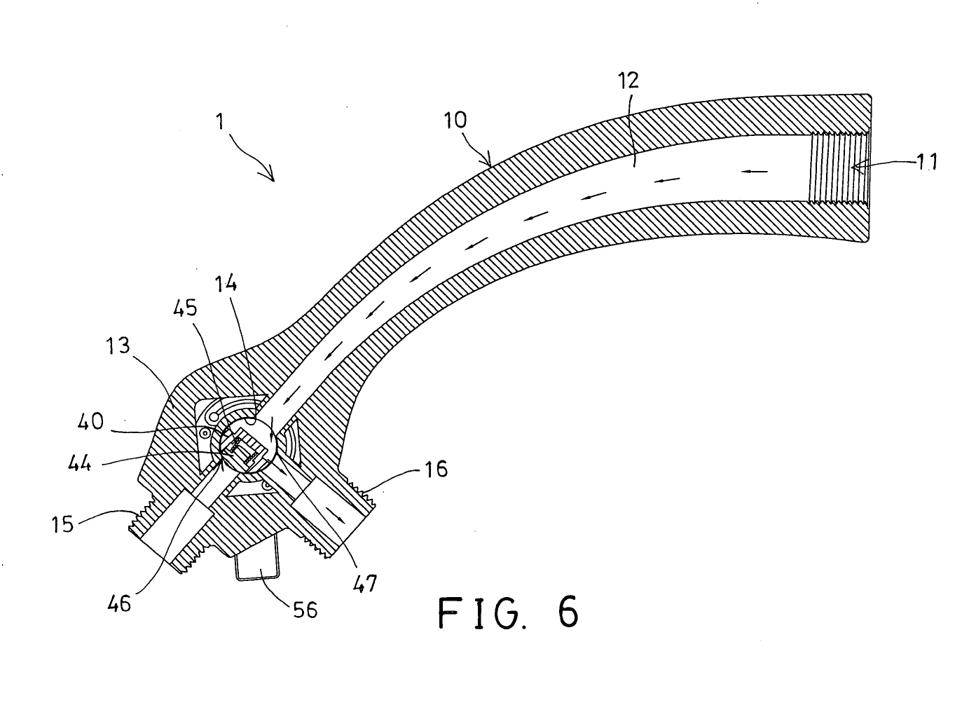

The valve stem 40 includes a compartment 43 formed therein, for receiving a valve member 44 and a spring member 45 which may bias the valve member 44 to engage with either of two valve seats 46, 47 that are formed in the housing 13 or the shower arm 10, and that are communicating with the outlet ports 15, 16 of the shower arm 10 respectively. For example, as shown in FIG. 6, the spring member 45 may bias the valve member 44 to engage with the valve seat 46, and thus to block the outlet port 15 of the shower arm 10, and to prevent the water to flow out through the shower head 20 that is attached to the outlet port 15 of the shower arm 10, and arranged to allow the water to flow out through the sprayer nozzle 23 via the other outlet port 16 of the shower arm 10.

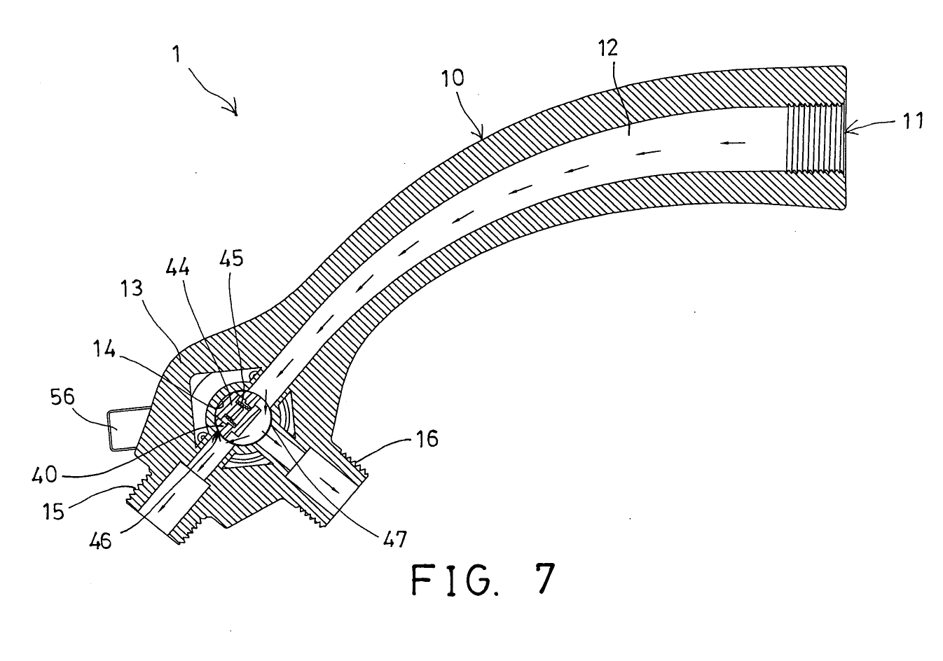

As shown in FIG. 5, the spring member 45 may also selectively bias the valve member 44 to engage with the other valve seat 47, and thus to block the other outlet port 16 of the shower arm 10, and to prevent the water to flow out through the sprayer nozzle 23 that is attached to the other outlet port 16 of the shower arm 10, and arranged to allow the water to flow out through the shower head 20 via the outlet port 15 of the shower arm 10. As shown in FIG. 7, alternatively, the valve member 44 may also be arranged to be disengaged from the valve seats 46, 47 of the housing 13 or of the shower arm 10, and thus to open the outlet ports 15, 16 of the shower arm 10, and thus to allow the water to flow out through the shower head 20 via the outlet port 15 of the shower arm 10 and to flow out through the sprayer nozzle 23 via the outlet port 16 of the shower arm 10.

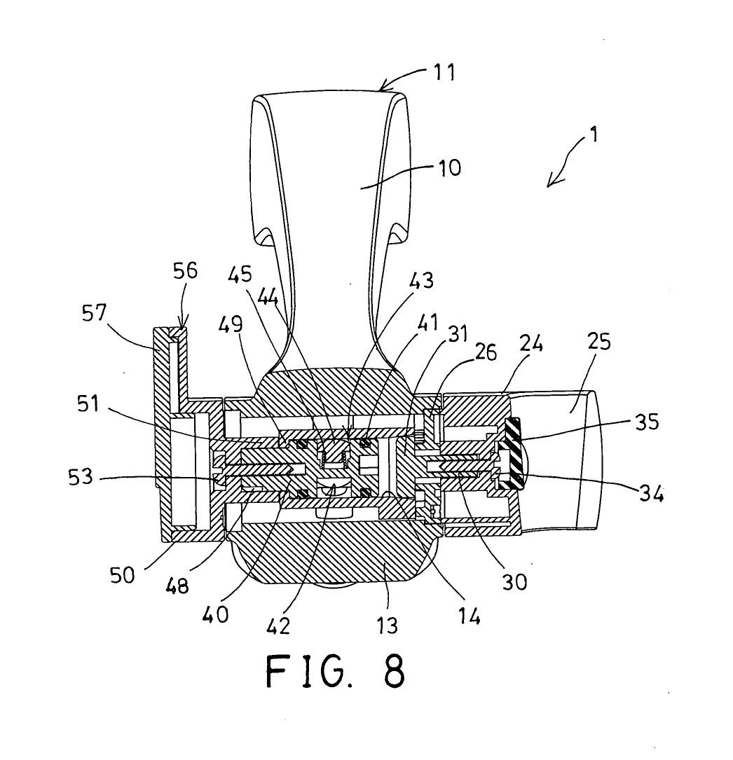

The valve stem 40 includes one end portion 48 (FIG. 3) for attaching or securing to a handgrip or knob 50 which may be used to rotate or to operate the valve stem 40 relative to the housing 13 or the shower arm 10. The valve stem 40 may thus be used and acted as a controlling means or device for controlling the water to flow out through either or both of the shower head 20 and the sprayer nozzle 23. As shown in FIGS. 8, 9, the shower arm 10 may further include a peripheral stop 49 extended therein, such as extended into the chamber 14 of the housing 13, for engaging with the valve stem 40, and for rotatably anchoring the valve stem 40 to the housing 13 or the shower arm 10, and thus for preventing the valve stem 40 from sliding laterally or longitudinally relative to the housing 13 or the shower arm 10.

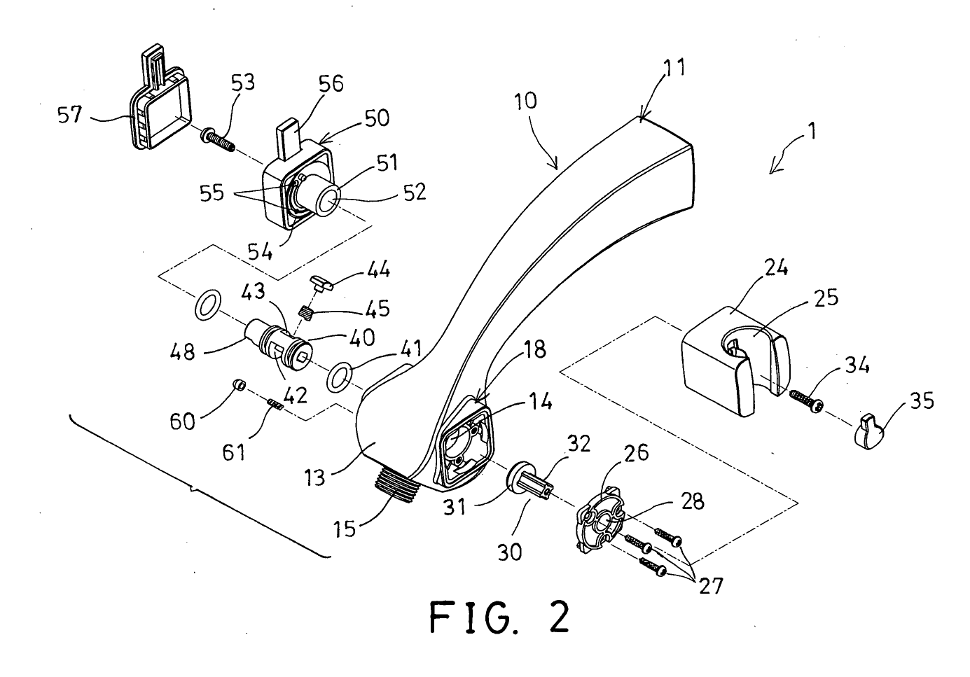

The knob 50 includes a barrel 51 extended therefrom and having a cavity 52 formed therein (FIG. 2) for receiving the end portion 48 of the valve stem 40, which may further be solidly secured to the knob 50 with one or more fasteners 53, to solidly secure the valve stem 40 to the knob 50. It is preferable that the cavity 52 of the barrel 51 and the end portion 48 of the valve stem 40 each includes a non-circular cross section, to prevent the valve stem 40 from being rotated relative to the knob 50. The knob 50 may further include a curved channel 54 formed therein (FIG. 2) and located around the barrel 51, and includes one or more, such as three depressions 55 formed therein and communicating with the curved channel 54 thereof, and includes one or more flaps 56 extended outwardly therefrom for allowing the knob 50 and thus of the valve stem 40 to be easily rotated relative to the housing 13 or the shower arm 10 with the knob 50. A lid 57 may further be provided and attached onto the knob 50, to enclose or to shield the fastener 53.

The housing 13 or the shower arm 10 may further include a stud 58 extended therefrom (FIG. 3), such as extended toward the knob 50 for receiving a projection 60 and a spring member 61 therein, in which the spring member 61 may bias the projection 60 to engage into either of the depressions 55 of the knob 50, to anchor or to position the knob 50 to the housing 13 or to the shower arm 10 at selected angular positions. For example, when the projection 60 is biased by the spring member 61 to engage into one of the depressions 55 of the knob 50, the valve member 44 may be positioned and maintained in engagement with the valve seat 46 (FIG. 6), to block the outlet port 15 of the shower arm 10, and to prevent the water to flow out through the shower head 20, and to allow the water to flow out through the sprayer nozzle 23.

When the projection 60 is biased by the spring member 61 to engage into the other depression 55 of the knob 50, the valve member 44 may be positioned and maintained in engagement with the other valve seat 47 (FIG. 5), to block the other outlet port 16 of the shower arm 10, and to prevent the water to flow out through the sprayer nozzle 23, and to allow the water to flow out through the shower head 20. When the projection 60 is biased by the spring member 61 to engage into the further depression 55 of the knob 50, the valve member 44 may be positioned and maintained in disengaging from the valve seats 46, 47 of the housing 13 or of the shower arm 10, to open the outlet ports 15, 16 of the shower arm 10, and to allow the water to flow out through the shower head 20 and the sprayer nozzle 23 via the outlet ports 15, 16 of the shower arm 10.

In operation, as shown in FIGS. 5-7, the valve stem 40 may be easily rotated relative to the housing 13 or the shower arm 10 with the knob 50, in order to control the water to flow out through either or both of the shower head 20 and the sprayer nozzle 23 via either or both of the outlet ports 15, 16 of the shower arm 10. In addition, both the shower head 20 and the sprayer nozzle 23 may be attached to the shower arm 10 that may be directly attached or secured to the water outlet tube 80, without drilling holes in the wall or the supporting surface 88. The attaching device 24 may optionally or selectively provided and attached or secured to the shower arm 10, for optionally or selectively hooking or attaching the sprayer nozzle 23 to the shower arm 10.

Accordingly, the holder device in accordance with the present invention may be directly attached to the water outlet tube that is typically provided and extended from the supporting surfaces or walls, for supporting shower heads and/or shower nozzles and the like, without drilling holes in the supporting surfaces or walls or the like, and for controlling the water to flow out through either or both of the shower heads and the nozzles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A holder device for attaching to a water outlet tube which is typically extended from a wall and coupled to a water reservoir, said holder device comprising:
a shower arm including an inlet for attaching to the water outlet tube, and for receiving water from the water reservoir, and including a housing provided thereon, said housing including a first outlet port and at least one second outlet port, and said housing including a chamber formed therein and communicating with said inlet and said first outlet port and said at least one second outlet port of said housing, and said housing including two valve seats formed in said housing and communicating with said first outlet port and said at least one second outlet port of said housing respectively,
a shower head attached to said first outlet port of said housing,
a sprayer nozzle coupled to said at least one second outlet port of said housing,
an attaching device attached to said housing for supporting said sprayer nozzle, said attaching device including an opening formed therein for attaching said sprayer nozzle,
a valve stem rotatably attached in said chamber of said housing, and including a passage formed therein for communicating said inlet of said housing with said first outlet port and said at least one second outlet port of said housing, to allow the water to selectively flow out through said first outlet port and said at least one second outlet port of said housing,
a spring-biased valve member received in said valve stem to engage with either of said valve seats of said housing and to control the water to flow out through said first outlet port and said at least one second outlet port of said housing, and
a knob secured to said valve stem to rotate said valve stem relative to said housing.

2. The holder device as claimed in claim 1, wherein said housing includes a partition secured thereto, said attaching device is rotatably attached to said partition.

3. The holder device as claimed in claim 2, wherein said partition includes a bore formed therein, a follower rotatably engaged in said bore of said partition secured to said attaching device.

4. The holder device as claimed in claim 3, wherein said follower includes at least one key extended therefrom for keying and securing to said attaching device, and includes an enlarged head extended therefrom, for engaging with said partition, and for rotatably anchoring said follower to said partition, and for preventing said follower from sliding relative to said partition.

5. The holder device as claimed in claim 1, wherein said valve stem includes a compartment formed therein, and said spring-biased valve member is received in said compartment of said valve stem.

6. The holder device as claimed in claim 1, wherein said housing includes a spring-biased projection disposed therein, and engageable with said knob, to position said knob to said housing at selected position.

7. The holder device as claimed in claim 1, wherein said knob includes a barrel extended therefrom and attached to said valve stem.
